(19) United States
(12) Patent Application Publication
(10) Pub. No.: US 2025/0118319 A1
(43) Pub. Date: Apr. 10, 2025

(54) Watermarking Output Audio For Alignment With Input Audio

(71) Applicant: Google LLC, Mountain View, CA (US)

(72) Inventors: Taral Pradeep Joglekar, Sunnyvale, CA (US); Alexander H. Gruenstein, Mountain View, CA (US); Turaj Zakizadeh Shabestary, San Francisco, CA (US)

(73) Assignee: Google LLC, Mountain View, CA (US)

(21) Appl. No.: 18/891,339

(22) Filed: Sep. 20, 2024

Related U.S. Application Data
(60) Provisional application No. 63/587,989, filed on Oct. 4, 2023.

(51) Int. Cl. G10L 21/0216; G10L 21/0208

(52) U.S. Cl. CPC G10L 21/0216; G10L 2021/02082; G10L 2021/02166

(57) ABSTRACT

A method includes receiving an audible response to a query, and prior to playing back the audible response, providing, for output from an acoustic speaker, an alignment output audio stream that encodes an audio watermark. The method also includes receiving an alignment input audio stream captured by a microphone array and encoding an acoustic echo of the audio watermark, processing the alignment input audio stream to detect the acoustic echo, and determining a time alignment value between the alignment output audio stream and the alignment input audio stream. The method also includes playing back a response output audio stream that encodes the audible response and receiving an input audio stream. The input audio stream includes acoustic echo corresponding to the audible response played back. The method also includes processing the input audio stream to generate a respective target audio signal that cancels the acoustic echo.

### CROSS-REFERENCE TO RELATED APPLICATIONS

This U.S. Patent Application claims priority under 35 U.S.C. § 119(e) to U.S. Provisional Application 63/587,989, filed on Oct. 4, 2023. The disclosure of this prior application is considered part of the disclosure of this application and is hereby incorporated by reference in its entirety.

### TECHNICAL FIELD

This disclosure relates to watermarking output audio for alignment with input audio.

### BACKGROUND

Speech-enabled devices are capable of generating synthesized audio and playing back the synthesized audio from an acoustic speaker to one or more users within a speech environment. While the speech-enabled device plays back the synthesized audio, a microphone array of the speech-enabled device may capture an acoustic echo of the synthesized audio while actively capturing speech spoken by a user directed toward the speech-enabled device. Unfortunately, the acoustic echo originating from playback of the synthesized audio may make it difficult for a speech recognizer to recognize the speech spoken by the user that occurs during the acoustic echo of the synthesized audio.

### SUMMARY

One aspect of the disclosure provides a computer-implemented method that when executed on data processing hardware causes the data processing hardware to perform operations that include receiving, from a digital assistant, an audible response to a query directed toward the digital assistant, and prior to playing back the audible response to the query from an acoustic speaker, providing, for output from the acoustic speaker, an alignment output audio stream that encodes an audio watermark. The operations also include receiving an alignment input audio stream captured by a microphone array of one or more microphones and encoding an acoustic echo of the audio watermark, processing the alignment input audio stream to detect the acoustic echo of the audio watermark encoded in the alignment input audio stream, and based on detecting the acoustic echo of the audio watermark encoded in the alignment input audio stream, determining a time alignment value between the alignment output audio stream output from the acoustic speaker and the alignment input audio stream captured by the microphone array. The operations also include playing back from the acoustic speaker a response output audio stream that encodes the audible response to the query and receiving an input audio stream captured by the microphone array. The input audio stream includes acoustic echo corresponding to the audible response to the query played back from the acoustic speaker. The operations also include processing, using an acoustic echo canceler configured to receive the time alignment value, the input audio stream to generate a respective target audio signal that cancels the acoustic echo of the input audio stream.

Implementations of the disclosure may include one or more of the following optional features. In some implementations, the operations also include receiving, from the microphone array, a query input audio stream corresponding to the query directed toward the digital assistant, and based on the query input audio stream, obtaining the audible response to the query. In some examples, at least a portion of the alignment output audio stream that encodes the audio watermark: overlaps a query input audio stream in time or frequency; or overlaps the audible response to the query played back from the acoustic speaker in time or frequency.

The alignment output audio stream that encodes the audio watermark provided for audible output from the acoustic speaker may be imperceptible to a human ear. Additionally or alternatively, the alignment output audio stream that includes the audio watermark may be non-periodic.

In some implementations, the audio watermark includes an ultrasonic signal encoded in the alignment output audio stream. In some examples, the data processing hardware executes the acoustic echo canceler and resides on a user device associated with a user that issued the query. In these examples, the microphone array and the acoustic speaker may each reside on the user device. At least one of the microphone array or the acoustic speaker may reside on another device in communication with the user device. In some implementations, a portion of the input audio stream further includes an audio signal representing target speech captured by the microphone array and the respective target audio signal that cancels the acoustic echo of the input audio stream preserves the target speech. Here, the target speech is spoken while the audible response to the query is played back from the acoustic speaker.

Another aspect of the disclosure provides a system that includes data processing hardware and memory hardware storing instructions that when executed on the data processing hardware causes the data processing hardware to perform operations that include receiving, from a digital assistant, an audible response to a query directed toward the digital assistant, and prior to playing back the audible response to the query from an acoustic speaker, providing, for output from the acoustic speaker, an alignment output audio stream that encodes an audio watermark. The operations also include receiving an alignment input audio stream captured by a microphone array of one or more microphones and encoding an acoustic echo of the audio watermark, processing the alignment input audio stream to detect the acoustic echo of the audio watermark encoded in the alignment input audio stream, and based on detecting the acoustic echo of the audio watermark encoded in the alignment input audio stream, determining a time alignment value between the alignment output audio stream output from the acoustic speaker and the alignment input audio stream captured by the microphone array. The operations also include playing back from the acoustic speaker a response output audio stream that encodes the audible response to the query and receiving an input audio stream captured by the microphone array. The input audio stream includes acoustic echo corresponding to the audible response to the query played back from the acoustic speaker. The operations also include processing, using an acoustic echo canceler configured to receive the time alignment value, the input audio stream to generate a respective target audio signal that cancels the acoustic echo of the input audio stream.

This aspect of the disclosure may include one or more of the following optional features. In some implementations, the operations also include receiving, from the microphone array, a query input audio stream corresponding to the query directed toward the digital assistant, and based on the query input audio stream, obtaining the audible response to the query. In some examples, at least a portion of the alignment output audio stream that encodes the audio watermark: overlaps a query input audio stream in time or frequency; or overlaps the audible response to the query played back from the acoustic speaker in time or frequency.

The alignment output audio stream that encodes the audio watermark provided for audible output from the acoustic speaker may be imperceptible to a human ear. Additionally or alternatively, the alignment output audio stream that includes the audio watermark may be non-periodic.

In some implementations, the audio watermark includes an ultrasonic signal encoded in the alignment output audio stream. In some examples, the data processing hardware executes the acoustic echo canceler and resides on a user device associated with a user that issued the query. In these examples, the microphone array and the acoustic speaker may each reside on the user device. At least one of the microphone array or the acoustic speaker may reside on another device in communication with the user device. In some implementations, a portion of the input audio stream further includes an audio signal representing target speech captured by the microphone array and the respective target audio signal that cancels the acoustic echo of the input audio stream preserves the target speech. Here, the target speech is spoken while the audible response to the query is played back from the acoustic speaker.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example speech environment and system using an acoustic echo cancelation (AEC) system.

FIG. 2 is a schematic view of an example of an AEC system.

FIG. 3 is a flowchart of an example arrangement of operations for a method of implementing an AEC system.

FIG. 4 is a schematic view of an example computing device that may be used to implement the systems and methods described herein.

Like reference symbols in the various drawings indicate like elements.

### DETAILED DESCRIPTION

Speech-enabled devices are capable of generating synthesized audio and playing back the synthesized audio from an acoustic speaker to one or more users within a speech environment. Here, synthesized audio refers to audio generated by a speech-enabled device that originates from the speech-enabled device itself or generated by machine processing systems associated with the speech-enabled device rather a person or other source of audible sound external to the speech-enabled device. Generally speaking, the speech-enabled device outputs, or plays back, synthesized audio generated by a text-to-speech (TTS) system. A TTS system converts text to an output audio stream that encodes the text, where the output audio stream is modeled to sound like that of an utterance spoken by a human.

While an audio output component (e.g., an acoustic speaker) of the speech-enabled device outputs/plays back the synthesized audio, an audio capturing component (e.g., a microphone array of one or more microphones) of the speech-enabled device may be simultaneously capturing (i.e., listening to) audio signals within the speech environment. This means that an acoustic echo of the synthesized audio played back from the acoustic speaker may be captured by the audio capturing component. Here, an acoustic echo of the synthesized audio includes a modified or delayed version of the played back synthesized audio. Modifications or delay of the synthesized audio may occur due to the played back synthesized audio acoustically encountering, being modified by, and/or reflecting off of surfaces in the speech environment. Unfortunately, it is difficult for a speech recognizer to accurately recognize speech spoken by a user while acoustic echo corresponding to played back synthesized audio is captured simultaneously. That is, the overlapping acoustic echo may compromise the speech recognizer's ability to generate an accurate transcript of the spoken utterance. Without an accurate transcript from the speech recognizer, the speech-enabled device may fail to accurately respond to, or respond at all to, a query or a command from a spoken utterance by the user. Alternatively, the speech-enabled device may want to avoid using its processing resources attempting to interpret audible sound that is actually acoustic echo from the synthesized audio signal and/or from the surroundings.

One approach to combat distortion or acoustic echo captured by audio capturing components of the speech-enabled device is to use an acoustic echo cancelation (AEC) system. The AEC system uses content of an output audio stream to cancel an acoustic echo of the output audio stream that is present in an input audio stream in a delayed and/or modified form. Here, the AEC system cancels the acoustic echo by removing at least a portion of the acoustic echo present in the input audio signal. The portion of the acoustic echo that is not removed by the AEC system may be referred to as residual echo. The performance of the AEC system (e.g., how much acoustic echo it cancels) is sensitive to the AEC system's ability to accurately determine a time alignment between the audio content played back from the acoustic speaker and an acoustic echo of the audio content captured by the microphone array. Here, a time alignment value represents a delay between when a sound is output by an acoustic speaker and when an acoustic echo of the sound is captured by a microphone array. Error or inaccuracy in time alignment determination may increase residual echo remaining in an input audio stream after echo cancellation and, thus, deteriorate the performance of a subsequent speech recognition system. Therefore, there is a need for systems and methods to accurately determine a time alignment for canceling acoustic echo.

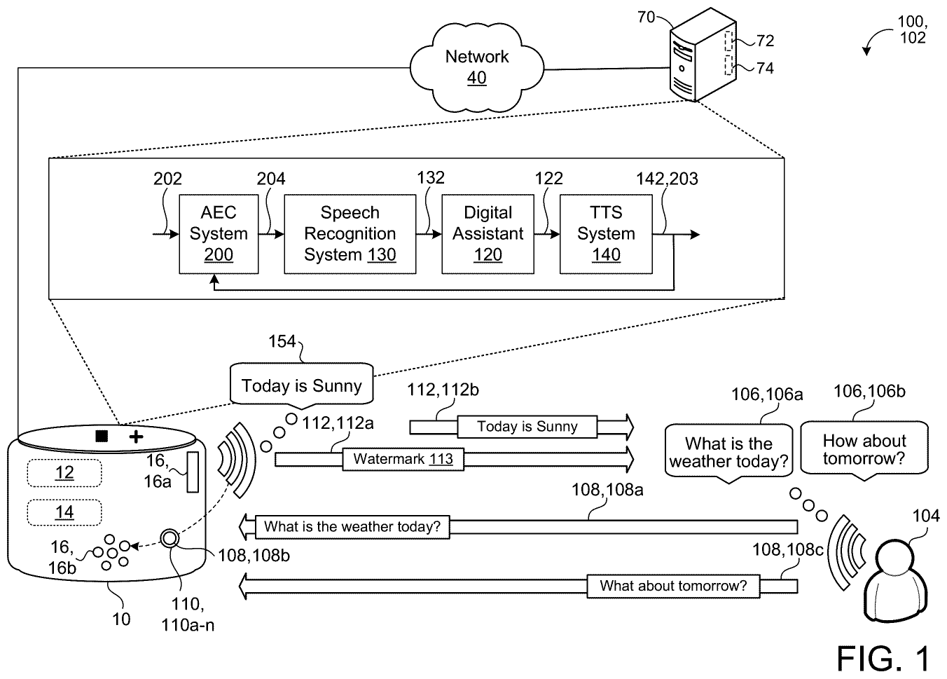

FIG. 1 is a schematic view of an example system 100 and an example speech environment 102 including a user 104 communicating spoken utterances 106, 106a-n to a speech-enabled device 10 (also referred to generally as a user device 10). The user 104 (i.e., speaker of the utterances 106) may speak an utterance 106 as a query or a command to solicit a response from the user device 10. The user device 10 is configured to capture input audio streams 108, 108a-c. Here, an input audio stream 108 is a logical construct that refers to a particular set of associated sounds in the speech environment 102 that occurred during a particular period of time. For example, an input audio stream 108 may represent the user 104 speaking a particular utterance 106 during a particular period of time. The user device 10 captures overlapping input audio streams 108 as a single stream of audio data 202 that contains an acoustic time-wise sum of the sounds of the overlapping input audio streams 108. The user device 10 may process a particular input audio stream 108 by processing a corresponding portion of input audio data 202 captured by an array of one or more microphones (hereinafter referred to as a ‘microphone array 16b’). However, the values of the corresponding portion of the input audio data 202 will also include contributions from other overlapping input audio streams 108. Here, the user device 10 does not need to specifically know or select what corresponding portion of input audio data 202 to process in order to process a particular input audio stream. Instead, processing a particular input audio stream 108 refers to the processing of input audio data 202 for a particular purpose, or simply the processing of input audio data 202 that includes contributions from the particular input audio stream 108. Similarly, the user device 10 may receive a particular input audio stream 108 by receiving a corresponding portion of input audio data 202 captured by the microphone array 16b. Here, the user device 10 does not need to specifically know or select what corresponding portion of input audio data 202 to receive in order to receive a particular input audio stream 108. Instead, receiving a particular input audio data 202 refers to the receiving of input audio data 202 for a particular purpose, or simply the receiving of input audio data 202 that includes contributions from the particular input audio stream 108.

Here, audio sounds may refer to a spoken utterance 106 by the user 104 that functions as an audible query, a command for the user device 10, or an audible communication captured by the user device 10. Speech-enabled systems 120, 130, and 140 of the user device 10, or associated with the user device 10, may field the query 106 for the command by answering the query 106 by playing back an audible response to the query 106 as an output audio stream 112, 112a-n, and/or causing the command to be performed. As used herein, an output audio stream 112 is a logical construct that refers to a particular set of associated sounds that are output into the speech environment 102 by the user device 10 during a particular period of time. For example, an output audio stream 112 may represent an audible response to a query 106. Outputting or playing back a particular output audio stream 112 refers to a time-wise addition of audio data representing the particular output audio stream 112 to a buffer of audio data that is being output from an acoustic speaker of the user device 10. Here, the user device 10 may output overlapping, non-overlapping, and partially overlapping output audio streams 112 by generating appropriate alignments of, and time-wise sums of, the audio data corresponding to the output audio streams 112. Input audio streams 108 captured by the user device 10 may also include acoustic echoes 110, 110a-n captured by the user device 10 as another input audio stream 108. Here, a particular acoustic echo 110 represents an acoustic echo of a particular output audio stream 112 output, or played back, by the user device 10.

The user device 10 may correspond to any computing device associated with the user 104 and capable of outputting output audio streams and receiving input audio streams. Some examples of user devices 10 include, but are not limited to, mobile devices (e.g., mobile phones, tablets, laptops, etc.), computers, wearable devices (e.g., smart watches, smart goggles, smart glasses, etc.), smart appliances, internet of things (IoT) devices, vehicle infotainment systems, smart speakers, smart assistant devices, etc. The user device 10 includes data processing hardware 12 and memory hardware 14 in communication with the data processing hardware 12 and storing instructions, that when executed by the data processing hardware 12, cause the data processing hardware 12 to perform one or more operations.

The user device 10 includes one or more audio output devices 16, 16a (e.g., one or more acoustic speakers) for communicating or outputting output audio streams 112 representing audio content (e.g., synthesized audio) as one or more output audio streams 112 that encode audio content, and the microphone array 16b for capturing and converting input audio streams 108 within the speech environment 102 into audio data 202 that encodes audio present in the environment 102. While the user device 10 implements an acoustic speaker 16a in the example shown, the user device 10 may implement one or more acoustic speakers 16a either residing on the user device 10, in communication therewith, or a combination where one or more speakers reside on the user device 10 and one or more other speakers that are physically removed from the user device 10 but in communication with the user device 10. Similarly, the user device 10 may implement an array of microphones 16b without departing from the scope of the present disclosure, whereby one or more microphones 16b in the array may not physically reside on the user device 10, but be in communication with interfaces/peripherals of the user device 10. For example, the user device 10 may correspond to a vehicle infotainment system that leverages an array of microphones 16b positioned throughout the vehicle.

In some examples, the user device 10 includes one or more applications (i.e., software applications), where each application may utilize one or more speech processing systems 120, 130, 140 associated with user device 10 to perform various speech processing functions within the application. For instance, the user device 10 may include a digital assistant application 120 configured to converse, through spoken dialog, with the user 104 to assist the user 104 with various tasks. In other examples, the digital assistant application 120 or a media application is configured to playback audible output that includes media content (e.g., music, talk radio, podcast content, television content, movie content, etc.). Here, the digital assistant application 120 may communicate synthesized speech for playback from the acoustic speaker 16a as output audio streams 112 for communicating or conversing with, or assist, the user 104 with the performance of various tasks. For example, the digital assistant application 120 may audibly output synthesized speech that is responsive to queries/commands submitted by the user 104 to the digital assistant application 120. In additional examples, the audible content played back from the acoustic speaker 16a corresponds to notifications/alerts such as, without limitation, a timer ending, an incoming phone call alert, a doorbell chime, an audio message, etc.

The user device 10 may be configured to communicate via a network 40 with a remote computing system 70. The remote computing system 70 may include physical and/or virtual (e.g., cloud based) resources, such as data processing hardware 72 (e.g., remote servers or CPUs) and/or memory hardware 74 (e.g., remote databases or other storage hardware). The user device 10 may utilize the resources 72, 74 to perform various functionalities related to speech processing and/or synthesized playback communication. For instance, the user device 10 may be configured to perform speech recognition using a speech recognition system 130 (e.g., using a speech recognition model). Additionally, the user device 10 may be configured to perform conversion of text to speech using a text-to-speech (TTS) system 140, and acoustic echo cancelation using an acoustic echo cancellation (AEC) system 200. The systems 120, 130, 140, 200 may reside on the user device 10 (referred to as on-device systems) or reside remotely (e.g., reside on the remote computing system 70), but in communication with the user device 10. In some examples, some of the systems 120, 130, 140, 200 reside locally or on-device while others reside remotely. In other words, any of the systems 120, 130, 140, 200 may be local or remote in any combination. For instance, when a system 120, 130, 140, 200 is rather large in size or processing requirements, the system 120, 130, 140, 200 may reside in the remote computing system 70. Yet when the user device 10 may support the size or the processing requirements of one or more systems 120, 130, 140, 200, the one or more systems 120, 130, 140, 200 may reside on the user device 10 using the data processing hardware 12 and/or the memory hardware 14. Optionally, the one or more of the systems 120, 130, 140, 200 may reside on both locally/on-device and remotely. For instance, one or more of the systems 120, 130, 140, 200 may default to execute on the remote computing system 70 when a suitable connection to the network 40 between the user device 10 and remote computing system 70 is available, but when the connection is lost or unsuitable, or the network 40 is unavailable, the systems 120, 130, 140, 200 instead execute locally on the user device 10.

A speech recognition system 130 receives audio data 204 as input and transcribes that audio data 204 into a transcription 132 as output. Generally speaking, by converting the audio data 204 into the transcription 132, the speech recognition system 130 allows the user device 10 to recognize when a spoken utterance 106 from the user 104 corresponds to a query, a command, or some other form of audio communication. The transcription 132 refers to a sequence of text that the user device 10 may then use to generate a response to the query or the command. For instance, if the user 104 asks the user device 10 the query 106a of “what is the weather today,” the user device 10 passes the audio data 204 corresponding to the spoken utterance 106a of “what is the weather today” to the speech recognition system 130. The speech recognition system 130 converts the audio data 204 for the utterance 106a into a transcript 132 that includes the text of “what is the weather today?” The digital assistant 120 may then determine a response to the query 106a using the text or portions of the text. For instance, in order to determine the weather for the current day (i.e., today), the digital assistant 120 passes the text (e.g., “what is the weather today?”) or identifying portions of the text (e.g., “weather” and “today”) to a search engine (not shown for clarify of illustration). The search engine may then return one or more search results that the digital assistant 120 interprets to generate a response for the user 104.

The digital assistant 120 identifies text 122 that the user device 10 will communicate to the user 104 as an audible response to a query of a spoken utterance 106. The user device 10 may then use the TTS system 140 to convert the text 122 into corresponding synthesized audio 142 for the user device 10 to communicate to the user 104 (e.g., audibly communicate to the user 104) as the response to the query of the spoken utterance 106. In other words, the TTS system 140 receives, as input, text 132 and converts the text 132 into synthesized audio 142 where the synthesized audio 142 is an output audio signal defining an audible rendition of the text 122. In some examples, the TTS system 140 includes a text encoder that processes the text 122 into an encoded format (e.g., a text embedding). Here, the TTS system 140 may use a trained TTS model to generate the synthesized audio 142 from the encoded format of the text 122. Once generated, the TTS system 140 communicates the synthesized audio 142 to the user device 10 to allow the user device 10 to output the synthesized audio 142 as an output audio stream 112. For instance, the user device 10 outputs an output audio stream 112b representing “today is sunny” from the speaker 16a of the user device 10.

In an example, the speech recognition system 130 receives, via the microphone array 16b, an input audio stream 108a corresponding to a query directed to the digital assistant application 120. The digital assistant 120 then generates an audible response to the query 106a. Here, the speech recognition system 130 may process the input audio stream 108a to generate a transcript 132 of the query and passes the transcript 132 to the digital assistant application 120 so that the digital assistant application 120 can ascertain a text response 122 to the query 106a. Thereafter, the TTS system 140 may convert the text response 122 from the digital assistant application 120 into the output audio stream 112b as the audible response to the query 106a.

With continued reference to FIG. 1, when the user device 10 outputs the synthesized audio 142 (e.g., synthesized speech), the synthesized audio 142 may result in an acoustic echo 110 that is captured by the microphone array 16b. Unfortunately, in addition to the acoustic echo 110, the microphone array 16b may also be simultaneously capturing another input audio stream 108c corresponding to another spoken utterance 106b from the user 104 that corresponds to target speech directed toward the user device 10. For example, FIG. 1 depicts that, as the user device 10 outputs the synthesized audio 142 representing “today is sunny” as the output audio stream 112b, the user 104 inquires more about the weather, in another spoken utterance 106b to the user device 10, by asking “what about tomorrow?” Notably, the user 104 speaks the utterance 106b as part of a continued conversation scenario where the user device 10 maintains the microphone array 16b open and the speech recognition system 130 active to permit the user 104 to provide follow-up queries for recognition by the speech recognition system 130 without requiring the user 104 to speak a hotword (e.g., a predetermined word or phrase that when detected triggers the user device 10 to invoke speech recognition). In the example shown, the input audio stream 108c for “what about tomorrow?” temporally overlaps with the output audio stream 112b for “today is sunny.” Thus, microphone array 16b captures both the audio data 202 for the utterance 106b and at least a portion of the acoustic echo 10 corresponding to the synthesized audio 142 played back in the output audio stream 112b. That is, the acoustic echo 110 for the output audio stream 112b and the input audio stream 108c are both captured by the microphone array 16b simultaneously to form the audio data 202.

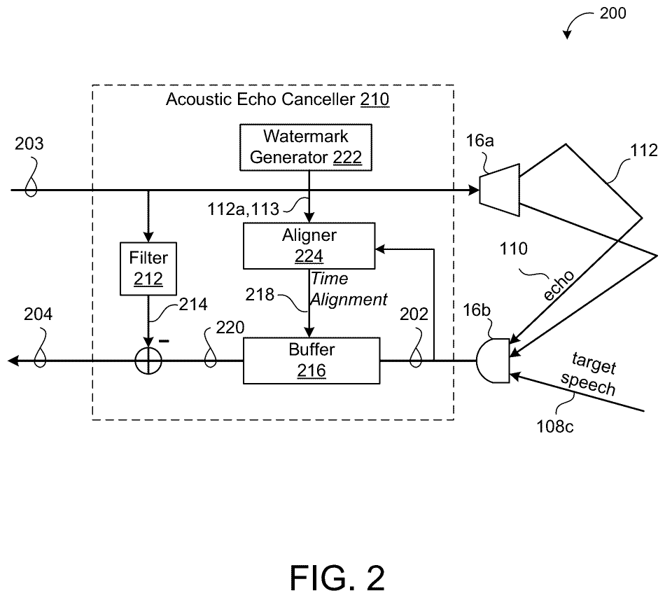

To resolve this, the user device 10 includes the AEC system 200 to process the audio data 202 to cancel acoustic echo 110 in the audio data 202, and provide the output 204 of the AEC system 200 (possibly including residual echo) to the speech recognition system 130. The AEC system 200 receives an input audio stream 108 captured by the microphone array 16b, the input audio stream 108 including acoustic echo 110 corresponding to a response to a query played back from the acoustic speaker 16a and processes, using an acoustic echo canceler 210 (see FIG. 2) configured to receive a time alignment value 218, the input audio stream 108 to generate a respective target audio signal 204 that cancels the acoustic echo 110 of the input audio stream 108.

With reference to FIG. 2, the AEC system 200 (FIG. 2) includes an acoustic echo canceller 210 that receives input audio data 202 encoding one or more overlapping input audio streams 108. In the example shown in FIGS. 1 and 2, the input audio data 202 includes both an input audio stream 108c encoding the follow-up utterance 106b (i.e., a target utterance or speech) and an acoustic echo 110 of the audible response 112b. Here, the input audio stream 108c is spoken while the output audio stream 112b (e.g., containing contributions from multiple overlapping output audio streams 112) is being played back. The acoustic echo canceller 210 processes the output audio data 203 that is being played back by the acoustic speaker 16a and temporally overlaps the input audio data 202 with any number and/or type(s) of filters 212 to generate an estimate 214 of the acoustic echo 110 of the output audio stream 112b present in the input audio data 202. An example filter 212 is a time-domain filter that convolves coefficients of the filter 212 with samples of the output audio data 203. The acoustic echo canceller 210 includes a buffer 216 (e.g., a circular buffer) for time aligning the input audio data 202 with the output audio data 203 based on a time alignment value 218 to generate aligned input audio data 220. Here, use of the buffer 216 may reduce the complexity of the filter 212 by not requiring the filter 212 to have excess coefficients to accommodate time alignment differences between the output audio data 204 and the input audio data 202. The acoustic echo canceller 210 then, as shown, subtracts the estimate 214 from the aligned input audio data 220 to cancel the acoustic echo 110 present in the aligned audio data 220 to generate a respective target audio signal 204 that cancels acoustic echo 110 of the output audio streams 112.

The acoustic echo canceller 210 executes a watermark generator 222 and an aligner 224 for determining the time alignment value 218. The watermark generator 222 generates an alignment output audio stream 112a that encodes an audio watermark 113 for output from the acoustic speaker 16a. Here, the audio watermark 113 may be selected to be robust to distortions caused by a digital-to-analog converter, the acoustic speaker 16a, the microphone array 16b, or an analog-to-digital converter. Moreover, the audio watermark may be selected to reduce or minimize distortion to other output audio streams 112. Furthermore, the audio watermark 113 may be any number and/or type(s) of audible signals that are imperceptible to a human ear. In some implementations, the audio watermark 113 may include audio frequencies that are higher or lower than human hearing range. That is, the audio frequencies of the audio watermark 113 may not spectrally overlap with the human hearing range, an audible response 112b to a query 106 played back from the acoustic speaker 16a, or a follow-up query/utterance 106 spoken by a user. For example, the audio watermark 113 may include frequencies that are greater than 20 kHz or less than 20 Hz. In some examples, the audio watermark includes an ultrasonic signal encoded in the alignment output audio stream 112a. With ultrasonic watermarking, the acoustic echo canceller 210 can perform time alignment after (or even during) the user's query 106a, and before the digital assistant application 120 begins responding to the query 106a. In some implementations, the audio watermark(s) 113 encoded into the alignment output audio stream 112a includes audible sounds that are within or partially within the human hearing range but are not detectable by humans because of its volume or because it includes sounds similar to noise. For example, the audio watermark may include a frequency pattern between 8 and 10 kHz. The strength of different frequency bands may be imperceptible to a human, but may be detectable by a computing device. In some examples, the audio watermark 113 is non-periodic, has a short time period (e.g., a burst), or has a long time period.

In some implementations, the watermark generator 222 generates and provides the alignment output audio stream 112a that encodes the watermark 113 as output prior to the user device 10 playing back an audible response 112b to a query 106 or even prior to generating the audible response. This can be beneficial because otherwise time alignment may only be performed after the output audio stream 112b begins being played back, which may cause delays. Here, the alignment output audio stream 112a may partially overlap the playback of the audible response 112b. Moreover, the alignment output audio stream 112a may partially overlap an input audio stream 108 corresponding to a query 106 captured by the microphone array 16b. In some examples, when a time since a previous alignment output audio stream 112a output from the user device 10 exceeds a predetermined threshold, the watermark generator 222 generates and provides the alignment output audio stream 112a as output before the user device 10 plays back an audible response 112 to a query 106. Alternatively, the watermark generator 222 generates and provides the alignment output audio stream 112a as output before the user device 10 plays back each audible response to each query 106 directed toward the digital assistant 120, or after a predetermined number of audible responses 112b to queries 106 are played back. In some implementations, the digital assistant application 120 triggers the watermark generator 222 to generate and provide the alignment output audio stream 112a as output. In these implementations, the digital assistant application 120 may trigger the watermark generator 222 to generate and provide the alignment output audio stream 112a as output from the user device 10 responsive to receiving a query 106.

Using any number and/or type(s) of methods or algorithms, the aligner 224 determines a time alignment value 218 (e.g., a duration of delay or offset) between the alignment output audio stream 112a and an input alignment audio stream 108b subsequently captured by the microphone array 16b. In particular, the aligner 224 may process the alignment input audio stream 108b captured by the microphone array 16b to detect an acoustic echo of the audio watermark 113 encoded in the alignment input audio stream 108b and, based on detecting the echo of the audio watermark 113 encoded in the alignment input audio stream 112b, determine the time alignment value 218 between the alignment output audio stream 112a output from the acoustic speaker 16a and the alignment input audio stream 108b captured by the microphone array 16b. In some implementations, the aligner 224 adjusts, based on a first portion of an input audio stream 108 captured by the microphone array 16b, the time alignment value 218, wherein processing the input audio stream 108 to generate the respective target audio signal 204 includes processing, using the acoustic echo canceler 210, based on the adjusted time alignment value 218, the input audio stream 108 to cancel an acoustic echo 110 present in a second portion of the input audio stream 108.

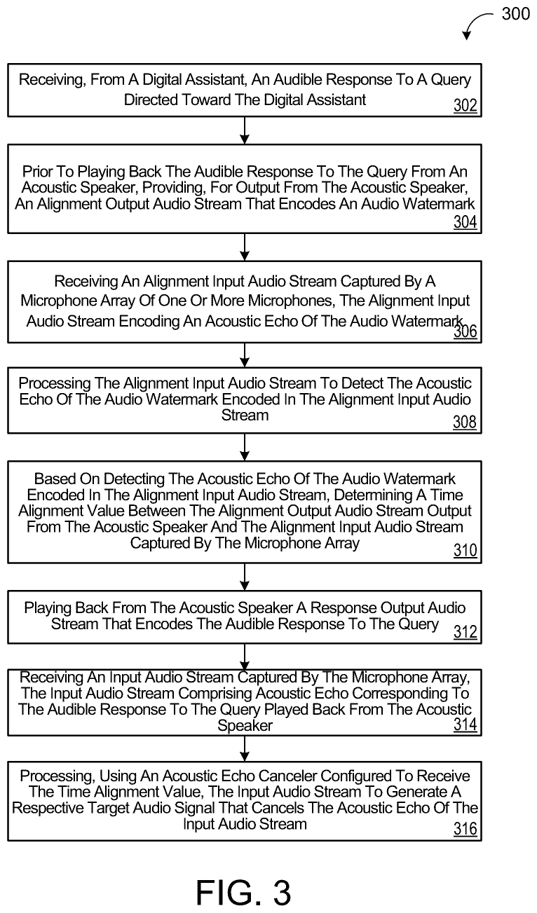

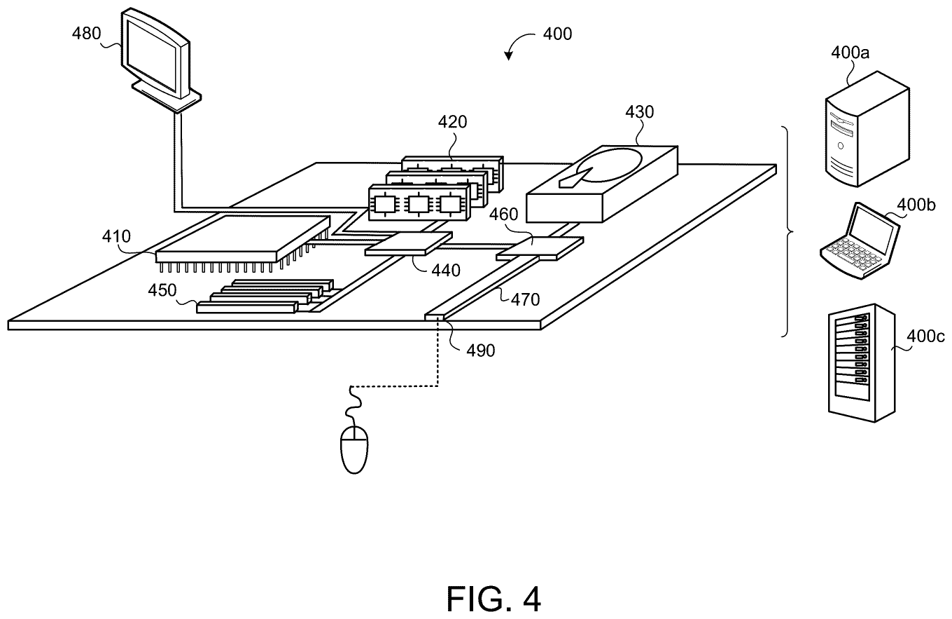

FIG. 3 is a flowchart of an example arrangement of operations for a method 300 of canceling acoustic echo. The operations may be performed by data processing hardware 410 (FIG. 4) (e.g., the data processing hardware 12 of the user device 10 or the data processing hardware 72 of the remote computing system 70) based on executing instructions stored on memory hardware 420 (FIG. 4) (e.g., the memory hardware 14 of the client device 10 or the memory hardware 74 of the remote computing system 70).

At operation 302, the method 300 includes receiving, from a digital assistant application 120, an audible response 112b to a query 106a directed toward the digital assistant application 120. At operation 304, the method 300 includes, prior to playing back the audible response 112b to the query 106a from an acoustic speaker 16a, providing, for output from the acoustic speaker 16a, an alignment output audio stream 112a that encodes an audio watermark 113. At operation 306, the method 300 includes receiving an alignment input audio stream 108b captured by a microphone array 16b of one or more microphones. Here, the alignment input audio stream 108b encodes an acoustic echo 110 of the audio watermark.

At operation 308, the method 300 includes processing the alignment input audio stream 108b to detect the acoustic echo 110 of the audio watermark encoded in the alignment input audio stream 108b. At operation 310, the method 300 includes, based on detecting the acoustic echo 110 of the audio watermark encoded in the alignment input audio stream 108b, determining a time alignment value 218 between the alignment output audio stream output 112a from the acoustic speaker 16a and the alignment input audio stream 108b captured by the microphone array 16b.

At operation 312, the method 300 includes playing back from the acoustic speaker 16a a response output audio stream 112b that encodes the audible response to the query 106a. At operation 314, the method 300 includes receiving input audio data 202 representing an input audio stream 108c captured by the microphone array 16b, the input audio stream 108c or the input audio data 202 including acoustic echo 110 corresponding to the audible response to the query played back from the acoustic speaker 16a. At operation 316, the method 300 includes processing, using an acoustic echo canceler 210 configured to receive the time alignment value 218, the input audio stream 108c to generate a respective target audio signal 204 that cancels the acoustic echo 110 of the input audio stream 108c.

FIG. 4 is schematic view of an example computing device 400 that may be used to implement the systems and methods described in this document. The computing device 400 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 400 includes a processor 410 (i.e., data processing hardware) that can be used to implement the data processing hardware 12 and/or 72, memory 420 (i.e., memory hardware) that can be used to implement the memory hardware 14 and/or 74, a storage device 430 (i.e., memory hardware) that can be used to implement the memory hardware 14 and/or 74, a high-speed interface/controller 440 connecting to the memory 420 and high-speed expansion ports 450, and a low speed interface/controller 460 connecting to a low speed bus 470 and a storage device 430 that can be used to implement the repository 240. Each of the components 410, 420, 430, 440, 450, and 460, are interconnected using various busses, and may be mounted on a common motherboard or in other manners as appropriate. The processor 410 can process instructions for execution within the computing device 400, including instructions stored in the memory 420 or on the storage device 430 to display graphical information for a graphical user interface (GUI) on an external input/output device, such as display 480 coupled to high speed interface 440. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 420 stores information non-transitorily within the computing device 400. The memory 420 may be a computer-readable medium, a volatile memory unit(s), or non-volatile memory unit(s). The non-transitory memory 420 may be physical devices used to store programs (e.g., sequences of instructions) or data (e.g., program state information) on a temporary or permanent basis for use by the computing device 400. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 430 is capable of providing mass storage for the computing device 400. In some implementations, the storage device 430 is a computer-readable medium. In various different implementations, the storage device 430 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 420, the storage device 430, or memory on processor 410.

The high speed controller 440 manages bandwidth-intensive operations for the computing device 400, while the low speed controller 460 manages lower bandwidth-intensive operations. Such allocation of duties is exemplary only. In some implementations, the high-speed controller 440 is coupled to the memory 420, the display 480 (e.g., through a graphics processor or accelerator), and to the high-speed expansion ports 450, which may accept various expansion cards (not shown). In some implementations, the low-speed controller 460 is coupled to the storage device 430 and a low-speed expansion port 490. The low-speed expansion port 490, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 400a or multiple times in a group of such servers 400a, as a laptop computer 400b, or as part of a rack server system 400c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

These computer programs (also known as programs, software, software applications, or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Unless expressly stated to the contrary, the phrase “at least one of A, B, or C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least C; and (7) at least one A with at least one B and at least one C. Moreover, unless expressly stated to the contrary, the phrase “at least one of A, B, and C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least one C; and (7) at least one A with at least one B and at least one C. Furthermore, unless expressly stated to the contrary, “A or B” is intended to refer to any combination of A and B, such as: (1) A alone; (2) B alone; and (3) A and B.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed on data processing hardware that causes the data processing hardware to perform operations comprising:
receiving, from a digital assistant, an audible response to a query directed toward the digital assistant;
prior to playing back the audible response to the query from an acoustic speaker, providing, for output from the acoustic speaker, an alignment output audio stream that encodes an audio watermark;
receiving an alignment input audio stream captured by a microphone array of one or more microphones, the alignment input audio stream encoding an acoustic echo of the audio watermark;
processing the alignment input audio stream to detect the acoustic echo of the audio watermark encoded in the alignment input audio stream;
based on detecting the acoustic echo of the audio watermark encoded in the alignment input audio stream, determining a time alignment value between the alignment output audio stream output from the acoustic speaker and the alignment input audio stream captured by the microphone array;
playing back, from the acoustic speaker, a response output audio stream that encodes the audible response to the query;
receiving an input audio stream captured by the microphone array, the input audio stream comprising acoustic echo corresponding to the audible response to the query played back from the acoustic speaker; and
processing, using an acoustic echo canceler configured to receive the time alignment value, the input audio stream to generate a respective target audio signal that cancels the acoustic echo of the input audio stream.

2. The computer-implemented method of claim 1, wherein the operations further comprise:
receiving, from the microphone array, a query input audio stream corresponding to the query directed toward the digital assistant; and
based on the query input audio stream, obtaining the audible response to the query.

3. The computer-implemented method of claim 1, wherein at least a portion of the alignment output audio stream that encodes the audio watermark:
overlaps a query input audio stream in time or frequency; or
overlaps the audible response to the query played back from the acoustic speaker in time or frequency.

4. The computer-implemented method of claim 1, wherein the alignment output audio stream that encodes the audio watermark provided for audible output from the acoustic speaker is imperceptible to a human ear.

5. The computer-implemented method of claim 1, wherein the alignment output audio stream that encodes the audio watermark is non-periodic.

6. The computer-implemented method of claim 1, wherein the audio watermark comprises an ultrasonic signal encoded in the alignment output audio stream.

7. The computer-implemented method of claim 1, wherein the data processing hardware executes the acoustic echo canceler and resides on a user device associated with a user that issued the query.

8. The computer-implemented method of claim 7, wherein the microphone array and the acoustic speaker each reside on the user device.

9. The computer-implemented method of claim 7, wherein at least one of the microphone array or the acoustic speaker reside on another device in communication with the user device.

10. The computer-implemented method of claim 1, wherein:
a portion of the input audio stream further comprises an audio signal representing target speech captured by the microphone array, the target speech spoken while the audible response to the query is played back from the acoustic speaker; and
the respective target audio signal that cancels the acoustic echo of the input audio stream preserves the target speech.

11. A system comprising:
data processing hardware; and
memory hardware in communication with the data processing hardware, the memory hardware storing instructions that, when executed on the data processing hardware, causes the data processing hardware to perform operations comprising:
receiving, from a digital assistant, an audible response to a query directed toward the digital assistant;
prior to playing back the audible response to the query from an acoustic speaker, providing, for output from the acoustic speaker, an alignment output audio stream that encodes an audio watermark;
receiving an alignment input audio stream captured by a microphone array of one or more microphones, the alignment input audio stream encoding an acoustic echo of the audio watermark;
processing the alignment input audio stream to detect the acoustic echo of the audio watermark encoded in the alignment input audio stream;
based on detecting the acoustic echo of the audio watermark encoded in the alignment input audio stream, determining a time alignment value between the alignment output audio stream output from the acoustic speaker and the alignment input audio stream captured by the microphone array;
playing back, from the acoustic speaker, a response output audio stream that encodes the audible response to the query;
receiving an input audio stream captured by the microphone array, the input audio stream comprising acoustic echo corresponding to the audible response to the query played back from the acoustic speaker; and
processing, using an acoustic echo canceler configured to receive the time alignment value, the input audio stream to generate a respective target audio signal that cancels the acoustic echo of the input audio stream.

12. The system of claim 11, wherein the operations further comprise:
receiving, from the microphone array, a query input audio stream corresponding to the query directed toward the digital assistant; and
based on the query input audio stream, obtaining the audible response to the query.

13. The system of claim 11, wherein at least a portion of the alignment output audio stream that encodes the audio watermark:
overlaps a query input audio stream in time or frequency; or
overlaps the audible response to the query played back from the acoustic speaker in time or frequency.

14. The system of claim 11, wherein the alignment output audio stream that encodes the audio watermark provided for audible output from the acoustic speaker is imperceptible to a human ear.

15. The system of claim 11, wherein the alignment output audio stream that encodes the audio watermark is non-periodic.

16. The system of claim 11, wherein the audio watermark comprises an ultrasonic signal encoded in the alignment output audio stream.

17. The system of claim 11, wherein the data processing hardware executes the acoustic echo canceler and resides on a user device associated with a user that issued the query.

18. The system of claim 17, wherein the microphone array and the acoustic speaker each reside on the user device.

19. The system of claim 17, wherein at least one of the microphone array or the acoustic speaker reside on another device in communication with the user device.

20. The system of claim 11, wherein:
a portion of the input audio stream further comprises an audio signal representing target speech captured by the microphone array, the target speech spoken while the audible response to the query is played back from the acoustic speaker; and
the respective target audio signal that cancels the acoustic echo of the input audio stream preserves the target speech.
